(19) United States
(12) Patent Application Publication
(10) Pub. No.: US 2004/0215443 A1
(43) Pub. Date: Oct. 28, 2004

(54) Computers that communicate in the english language and complete work assignments by reading english language sentences

(76) Inventor: Charles Malcolm Hatton, Wheaton, IL (US)

Correspondence Address: CHARLES MALLOLM HATTON, THREE WHEATON CENTER, SUITE 210, WHEATON, IL, 60187, US

(21) Appl. No.: 09/917,146

(22) Filed: Jul. 27, 2001

(51) Int. Cl. G06F 17/20

(52) U.S. Cl. 704/1

(57) ABSTRACT

A computerized system to process English language sentences such that individual or networked computers can send and receive English language sentences to each other and carry out work instructions based on internal memories that link individual English language sentences together in order to perform high level computer skills. A computing system that allows input from devices, people, or data repositories such that the input consists of English language sentences that are matched to English language sentences stored in user defined memories where English language memories are networked together using English language sentences causing the computer to switch through its memory systems. English language sentences are stored in the computer's memory and can be attached to actions or English language sentences such that attached English language sentence(s) are processed in the computer's memory by sending them back to the computer's input or to other computers to perform computer work activities.

### BRIEF SUMMARY OF THE INVENTION

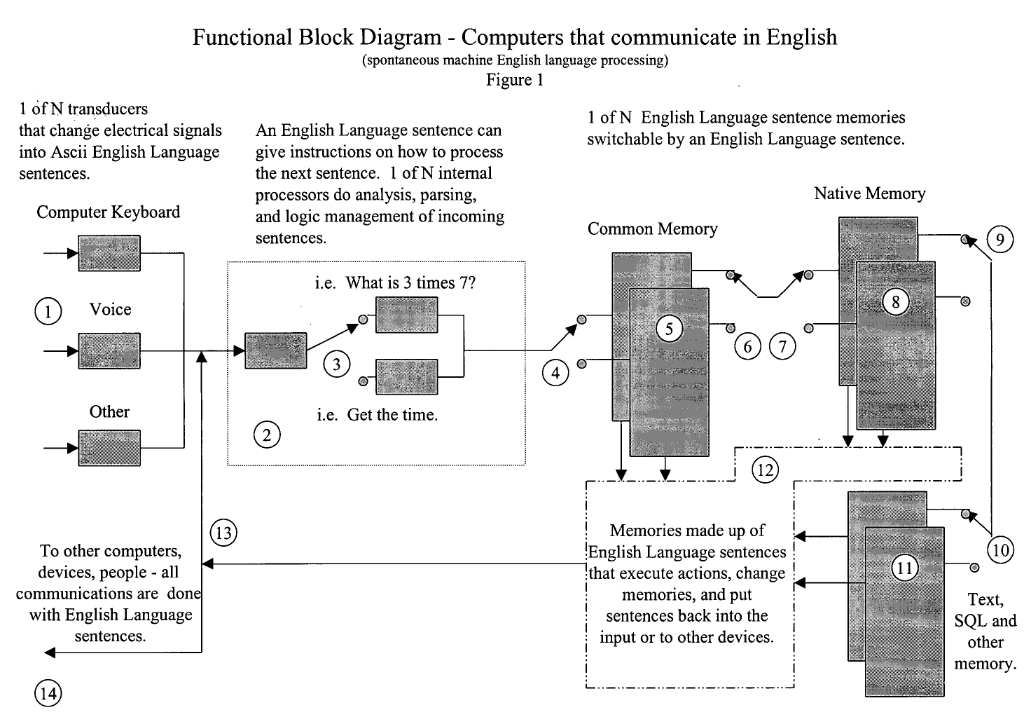

This patent application defines computer processes that support using the English language as a computer language. Specifically, methods are defined that let the computer: 1) process input English Language sentences from its memory which are also made up of English Language sentences. 2) use fuzzy logic to allow the computer to respond to differently worded sentences to arrive at the same action i.e., play a card game. Run solitaire. Where (play a game.) also plays the computer game of solitaire; 3) define contexts so that the computers can do: Go to New York. Who is Jim Smith? Go to Washington. Who is Jim Smith? Where answering the question, Who is Jim Smith? depends on the context: Go to New York or Go to Washington; 4) respond to multiple input sentences such as: What is the time. Get my word processor. Go to Greenburg. Who is Rod Smith; 5) where each sentence can be connected to other sentences so that in item 4) Get my word processor is connected to: Go to document memory. Get word; 6) process numbers in sentences to be variables or numbers i.e. play the game of 1.222 and What is 3.44 times 22.44; 7) use multi sentence so that one sentence preceding another can change the processing methods for the successor sentence such as: show to 2 decimal places. What is 3.3333 times 2.44467?—shows answer as 8.14; 8) build the computer's memory system from English language text files; 9) talk to each other in English so they can perform parallel computing; 10) use transducers to change voice, vision, touch, other signals to English language so the application can process those signals in its English language memory systems; 11) use any device to convert to the English language; 12) do inference or common sense reasoning to do the following: My car will not start. What should I do?; 13) use deductive based reasoning to do: My car will not start. What is wrong?; 14) integrate inference based reasoning with deductive based reasoning; 15) Make the computer read English language text files and store those text files in one of its memory systems; 16) make the text file that trained the application in (15) ask the application what it has learning to test that learning; 16) integrate English language data sets associated by sentence memory i.e. Go to English Works memory. Get the enhancement list. If not the enhancement list, then get design notes; 17) be a software agent to itself i.e. the said application calls another said application where the first said application is using the second said application and its specific English language memory systems to get data or cause an action or otherwise respond to the special need of the user in English; 18) conduct all correspondence to users or other devices in English as either imperative or declarative English language sentences; 19) dynamically change any or all sentence memories from external sources—take the existing sentence memories and switching them with new or different sentences memories; 20) define text and non text file memories as English language sentences; 21) make a series of sentences that are being processed to have another set of English Language sentences inserted such that the second set is a subset of the first or inserted somewhere in between the original first set of sentence and the original last set of sentences; 22) do inference based reasoning where the inference creates a new English language sentence such that this new sentence becomes new data for future inferences; 23) store English language sentences such that the same or similar sentence is stored on top of an existing sentence therefore preserving the original; 24) provide a command mode such that the said application just responds to nouns; 25) communicate in English from machine to machine and human to machine and machine to human; 26) utilize the Darwinian mechanism such that sentences created by the said application, independent of those created by the user in the storage of English Language sentences in any of the said applications memories, are created by said application using inferences so that said inferences (created as English Language sentences) can be applied against the existing memory system to see if a match can be found in said memory systems; 27) build English Language sentences by machine that describe events in the computer and can be stored in text files as memory; 28) accept files to reprogram itself and or have new functionality; 29) logically unite disparate activities called from the English Language so that English Language logical analysis can occur to resolve outcomes and make decisions based on the rules of human language and governing norms; 30) oversee human language rule patterns based on other systems in order to analyze those systems and propose new solutions; 31) automatically makes a set of sentences based on one input sentence so the said application can automatically search various memories (made up of English Language sentences) to find a target memory that satisfies the intent of the original sentence; 32) read text stored in text files imported by any means (video, or any transducer input) so that said application can make judgments of said text by said application based on storage of said application memory (made up of English Language sentences); 33) learn from other devices such that the said applications memories in FIG. 1 items (5), (8), and (11) are programmed in English Language sentences from outside devices either by human or machines where machines are defined as any non human device.

### DETAILED DESCRIPTION OF THE INVENTION

Description: Refer to FIG. 1. The computer application known as said application (this computer software application) describes methods that allow a computer to process English Language sentences of the type: Declarative, Imperative, Interrogative, and English Language keywords. Where input (1) (refer to FIG. 1 item (1)) takes in English Language text converted from 1 of N transducers. Text in ASCII format is fed to rule based parsers in FIG. 1 item (2) that analyze each input sentence and parse that sentence based, in some cases, on a previous sentence. Said sentence: (What is 3.333 times 2.444?) will display the answer to 2 places when previous sentence to (What is 3.333 times 2.444?) is: (display answer to 2 places.). Said input sentence (What is 3.333. times 2.444?) finds sentence type in Math memory when user tells the said computer application to: (go to math memory.). Sequence of said sentences to compute: (What is 3.333 times 2.444?) includes the following: (Go to math memory. Display answer 2 places. What is 3.333 times 2.444?). Note: said application will process multiple sentences separated by a period, question mark or exclamation mark.

Said application is configured to open a sentence memory form (8) or (11) memories. The currently open said memory points to a Math memory as defined by a sentence in the current open memory. User (human) or machine inputs sentence: (go to math memory) and instructs the said computer application to switch to Math memory. Said Math memory contains English Language sentences of type math such an input sentence of type: (What is 4 times 4?) matches (Number times Number) in stored memory sentence: (Number times Number is “This will multiply two numbers.”). Said sentence is a declarative sentence containing a noun and prepositional phrase (Number times Number) and a verb phrase: (is “This will multiply two numbers.”) containing the verb: is and the noun phrase contained within the double quotes: (“This will multiply two numbers”). Said sentence verb phrase contains a noun phrase defined with the double quotes even though its literal meaning is not a noun phrase. Said verb phrase is equal to: (is “ ”). Therefore, said equivalent sentence is: (Number times Number is “ ”.).

Said application switches to Math memory from said input sentence: (go to math memory.) (or may be done automatically when said application analyzes input sentence and switches between English Language sentence memories), Next sentence in input sentences instructs said computer application to: (display answer to 2 places.). This sentence is found in common memory at said location (5) and implements the said instruction based on the attached action(s) to this said input sentence.

In last sentence of the above 3 input sentences: (What is 3.333 times 2.444?) matches said math memory sentence: (Number times Number is “This will multiply two number.”) and displays the said answer: (The multiplication is 8.15).

The said computer application applies input sentences from said transducers show in FIG. 1 item (13) to memory systems in FIG. 1 items (5), (8), and (11) looking for fuzzy sentence matches which have attached actions for which any action can be an English Language sentences with is fed back into the input at FIG. 1 item (13). Said application memory is made up of English Language sentences and said application can have 1 of N memories as defined by a user or copied into the said application memory system from other users at FIG. 1 items (5), (8), and (11). A memory is called an object. Said input sentence is directed to 1 of N objects from a previous input sentence coming from an attached action of that sentence as in FIG. 1 items (5), (8), and (11) or from the input by a user or machine as in FIG. 1 item (1). Said input sentence in FIG. 1 item (1) or (13) where item (13) is an attached English Language sentence from said previous input sentence finds a fuzzy sentence match in current open object where said open object is selected by a previous input English Language sentence. Said open object containing English Language sentences may be matched by input sentence causing said object's sentence to execute said attached action. Said attached action can be the execution of a computer program, multiple attached English Language sentences or any program function within or outside of said application. Said computer application can send and English Language sentence in FIG. 1 items (13) and (14) to another computer running said computer application. In turn, said remote computer application can respond to said computer application English Language sentence by sending back an English Language sentence to said computer application. Said remote computer application may decide to send an English Language sentence(s) to other than first said computer application. Other said computer applications running on other said computers or other devices may eventually send an English Language sentence back to original said computer application.

Said objects (memory containing English Language sentences) of said computer application can be switched by a said input sentence coming from FIG. 1 item (1) or (13) such that same input can result in different actions depending on said open object. Said objects can contain same or (fuzzy similar) sentences across all objects but with different attached actions. Telling said application to: (go to your New York memory.) and asking: (Who is John Smith?) with said answer: (A person who makes shoes.) vs. telling said application to: (go to your Flordia memory.) and asking: (Who is John Smith?) with resulting said answer: (A person who lives at home.). Said application can send same input sentence (polymorphism) to said objects resulting in different results based on attachment to same sentence across all objects.

Said input sentence(s) coming from FIG. 1 items (1) or (13) may be used to expose said objects (memories located in FIG. 1 items (5), (8), and (11)) where said object is a class for said English Language sentences within said object. For example, directing said computer application to open its vehicle memory obect by telling said computer application to: (go to vehicle memory.) exposes the object's sentences to the next input sentence so that for example, next said input sentence coming from FIG. 1 items (1) or (13) could be: (What do cars do?). Said object memory (encapsulates) details of vehicles in said object memory. Once said vehicle object memory is open by telling said computer application at FIG. 1 items (1) or (13) to: (go to vehicle memory.) said next input sentence at FIG. 1 items (1) or (13) is exposed to all of said sentences stored in said vehicle object memory.

Said computer application uses (data abstraction) by telling said computer application at FIG. 1 items (1) and (13) to open its object memory. (where item (1) is input by human or other devices which compose an English Language sentence or item (13) where item (13) is an attached sentences stored in FIG. 1 items (5), (8), and (11)). Said object memory is open by input sentence and next input sentence is exposed to said open object memory. Said open object memory contains all information on the subject of said object such that any query to said open object memory will contain infromation relitive to the open object's memory. Said sentence: (go to my vehicle memory.) input at FIG. 1 items (1) or (13) exposes next said input sentence to object memories in FIG. 1 items (5), (8), and (11) to a sentence like: (What has 3 wheels?). Where the open memory vehicle object containing information on all vehicles or attached sentences to other object memories can respond to a specific requests for all types of vehicles.

Said application utilizes (inheritance at the object memory level) when said input sentence to said computer application in FIG. 1 items (1) and (13) causes said object memory to open in FIG. 1 item (8) and (11). Said open object memory contains a said sentence with attached action that causes a common object memory to open in FIG. 1 item (5). Said object memory in FIG. 1 items (8) and (11) inherits said corresponding common memory in FIG. 1 item (5) so that a base class of sentences is combined with other object memories and their sentences shown in FIG. 1 items (8) and (11). For example, said input sentence (go to your vehicle memory) in FIG. 1 item (1) and (13) causes said object memory to open in FIG. 1 item (8) or (11). Said open object memory contains a sentence with an attached sentence (FIG. 1 item (13)) to open 1 or N said common memories in FIG. 1 item (5). Both object memory sentences from FIG. 1 item (8) or (11) and item (5) are stored in computer RAM. User now inputs next input sentence at FIG. 1 item (1) or (13) to expose open object memories FIG. 1 item (5) and item (8) or FIG. 1 item (5) and item (11). The vehicle open object memory in FIG. 1 items (8) and (11), for example, will process input sentences at FIG. 1 items (1) and (13) about vehicle attributes for that open object memory, but it will also process input sentences regarding 2 and 3 wheeled vehicles based on sentences stored in the selected common object memory. Therefore, user inputs: (go to your vehicle memory.) and said computer application opens vehicle memory and then opens the related common memory that holds sentences and actions regarding 2 and 3 wheeled vehicles. In this regard the open vehicle memory in FIG. 1 item (8) or (11) inherits vehicle base class information from the corresponding common memory object in FIG. 1 item (5). Typical input sentences would be as follows: (open your vehicle memory. What do cars do? What has 2 wheels?). Where: (What has 2 wheels?) comes from sentences in the common object memory (FIG. 1 item (5) and opened by the sentence: (What do cars do?) located in object memories in FIG. 1 items (8) and (11).

Said application utilizes (inheritance at the sentence level) when said application process English Language sentences to do inference based reasoning. Said example sentences: (My car will not start. What should I do? vs. What is wrong? For deductive based reasoning) causes said application to answer: (take a taxi or other derived answer extracted from existing said application memory). Said application analyzes input sentences: (My car will not start. What should I do?) and reverses the order so that said input sentences become: (What should I do? My car will not start.) where said sentence: (What should I do?) causes common memory in FIG. 1 item (5) to set up logic in FIG. 1 item (2) so that said sentence: (My car will not start.) is processed using inference based reasoning. Attached action of the sentence (My car will not start.) stored in said application memory in FIG. 1 items (5), (8), and (11) is (Vehicles transport things. Go to vehicle memory.) where said application goes to its vehicle memory knowing its looking for an inference from the said application based on input sentence: (What should I do?). Said application process attached sentences: (Vehicles transport things. Go to vehicle memory.) which goes to input in FIG. 1 item (13) from (My car will not start.) isolating verb (transport) and applying a search in vehicle memory looking for same said verb (transport). Verb (transport) in said originating sentence with attached sentence: (Vehicles transport things.) also has a hierarchical number associated with the sentence: (Vehicles transport things.) of 1. In said target memory: (Go to vehicle memory.) searched verb (transport) at hierarchical number 1 is found in target memory with said sentence: (Cars transport people.) with attached inference: (Take a taxi.). Said application displays said inference solution to user (Take a taxi.) based on input sentences: (My car will not start. What should I do?).

The said application has many functions all of which can be implemented by inputting English Language sentences of the type declarative, imperative, interrogative, and exclamatory. To put the said application in the learn mode, a sentence like: (please learn.) and others using fuzzy logic (stored English Language sentences etc.) will store English language sentences in a declarative format. (Note that fuzzy logic is defined as storing an English Language declarative (factual) sentence in 1 of N memories shown in FIG. 1 in items (5), (8), and (11) such that the stored (learned sentence) defines like words by using an English Language thesaurus). All learned sentences will be stored in 1 of N computer memories at locations (5), (8), and (11) in FIG. 1. Teaching the said application to learn how to play the computer game of solitaire can be done by storing a declarative sentence like: (card game of solitaire is “Playing a solitaire card game.”) and attaching the solitaire program executable (sol.exe) to the said declarative sentence. Any number of attached actions can be stored with a learned declarative English Language sentence including other English Language sentences that are fed back into the input at FIG. 1 item (13) or to the output item (14). From the stored sentence: (card game of solitaire is “Playing a solitaire card game.”) any declarative, imperative, interrogative, and exclamatory sentence from machine to human can input an ASCII text sentence to play a solitaire card game using said application. Some of the word combinations include: (please play cards, get solitaire, play a game, load a card game, Can you play solitaire?) etc. These word combinations are formed using English Language sentence rules and implemented by humans or machines and input into said application in FIG. 1 item (1) or item (13) to match words in object memory in FIG. 1 items (5), (8), and (11). Said input sentences finds object memory sentence in FIG. 1 items (5), (8), and (11) which has been learned and stored by user in declarative English Language format as in: (card game of solitaire is “Playing a solitaire card game.”). Each of the input sentences (declarative, imperative, interrogative, and exclamatory) will match various words of the learned/stored declarative English Language sentence to cause said computer application to play the computer game of solitaire. The method described above in FIG. 1 item (5) and (8) learns declarative English Language sentences in Native mode and stores those sentences in 1 of N user object memories stored in computer files. File memories are defined by users and contain English Language declarative sentences and associated stored actions as defined by the user. A stored action is any event or another English Language sentence that may be attached to a stored declarative sentence. Said stored actions can instruct said application to switch to a new object memory file for which the next input English Language sentence from said transducers in FIG. 1 item (1) can cause new functionality to occur. Likewise said application can use text files (shown in FIG. 1 item (11)) that are English Language declarative sentences separated into paragraphs as shown in FIG. 2.

FIG. 2 (Items 1-22)

1. play a card solitaire game.

do: (sol.exe, c:\Windows).

display: Playing the card game of solitaire.

2. play a board chess game.

do: (chess.exe, c:\Windows).

display: Looking at my Files.

3. get my your this text paragraph file.

do: (notepad.exe, \Computer text memory\game text memory.txt).

4. who is Bill William Jefferson Clinton?

do: play cards.

do: show my computer files.

display: A guy who lives in New York.

related: His mother lives in Colorado.

5. who is Hillary Hilary Rodam Clinton?

display: Wife of the President of the United States.

related: Hillary's parents.

do: search. play cards.

6. get me picture map of England Great Britain.

do: (president.bmp, c:\MyPro386w\bitmap files\uk.bmp).

display: Showing a map of England.

7. find a chair car or boat.

do: play cards. go to core.

8. show my C disk drive space availability capacity amount on my C drive.

do: (Drvspace.exe, c:\).

display: Showing the c drive space.

8a. show my A disk drive space availability capacity amount on my C drive.

do: (Drvspace.exe, a:\).

display: Showing the a drive space.

8b. do disk clean or defragmentation.

do: (defrag.exe, c:\Windows).

display: defrag the selected disk drive.

9. who owns or is the owner of the Chicago and Northwestern?

do: play solitaire.

10. play a chess board game.

display: playing chess.

11. calla Person.

do: If get Person's phone number. then call Person. else call information.

display: sentence logic test. Also, Chuck's phone number should be asserted into memory which would allow call Chuck to happen.

12. call 411 information.

do: (sol.exe, c:\Windows).

12a. what does Intel PC notes makes computers easy to use say.

do: (Intel ease of use.bmp, c:\MyPro386w\bitmap files\Intel ease of use.bmp).

display: From Intel's web site on Dec. 15, 1998.

13. He was in New York getting his car.

display: getting his car in New York.

14. This is a Chuck test.

display: This is a Chuck test.

15. get calculator adder my math machine.

do: (calc.exe, c:\Windows).

display: can also be made into a scientific calculator.

16. something destroyed the bark.

do: play cards.

17. show my design note additions.

do: (notepad.exe, a:\other\design notes1).

display: These are the design notes on the ews diskette.

18. show the my problems issues list.

do: (notepad.exe, a:\Other\ews problem list).

display: Ews problem list.

19. go get the other next alternative Bill.

do: get test 1. Who is Bill. get test 2.

display: Getting information on the other Bill.

20. something destroyed the bark.

do: play cards.

21. get the new proposed functions functional capabilities notes list.

do: (notepad.exe, a:\Other\function list).

22. set up Ews development environment platforms software tools.

do: do Dos. show problem list. show functional notes. show design notes.

End of FIG. 2 (Items 1-22)

Said paragraphs of English Language declarative sentences can be matched by an input English Language sentence from machine to human of type declarative, imperative, interrogative, and exclamatory. Matching the input English Language sentence of type declarative, imperative, interrogative, and exclamatory with English Language declarative sentences stored in each text paragraph as shown in FIG. 2 such that one paragraph with attached actions for which one action can be made up of an English Language sentence will call another paragraph sentence who's attached action could call Native memory which switches to a new text file shown in FIG. 1 using mechanisms in items (5), (8), and (11). Text file memory switching will enable the following: (Go to Washington, D.C. What is Mr. Smith's phone number? Go to New York. What is Mr. Smith's phone number?). Where the sentences (Go to Washington, D.C. and Go to New York.) switch memories giving the said application through parsers in FIG. 1 item (2) the ability to point to a new set of English Language memories defined in FIG. 1 items (5), (8), and (11).

Said application can read a text files made of up of English Language sentences found by telling said computer application to go out and read said text file such that read text file teaches said application by transferring English Language sentences from said text files into said application in FIG. 1 item (1). Once said application has transferred English Language sentences into said application memory object in FIG. 1 item (8), said application continues to read said text file which further instructs said application, in English Language, to do what said computer application has learned by storing English Language sentences in said computer application object memory in FIG. 1 item (8). Said text file that teaches said computer application is shown in FIG. 3. Said application is told, using an English Language sentence in FIG. 1 item (1) or (13) to learn from a text file when user instructs said computer application to go out and read said text file. The said text file that teaches the said computer application to play the computer game of solitaire is as follows:

FIG. 3

Go to your learning memory. Save this data. “sol exe”.

Save the user sentence. “solitaire card game” is “playing solitaire”.

Stop learning text sentences. play solitaire. Go to your user memory.

End of FIG. 3

Said common memory in FIG. 1 item (5) contains English Language declarative sentences stored in ASCII text such that stored English Language sentence in common memory is matched with an input English Language input sentence of the form declarative, imperative, interrogative, and exclamatory located in FIG. 1 item (1) or (13) from machine or human. When said match is made in common object memory with input sentence, search of subsequent memories in FIG. 1 items (8) and (11) is prevented. If search of common memory fails to find a stored English Language sentence that matches input sentence using fuzzy logic, search continues in FIG. 1 item (8) and then to item (11). Said application in Native memory in FIG. 1 item (8) or item (11) can have a stored English Language sentence attached to a stored action that switches common memory in FIG. 1 item (6). Said common memory switches to a new set of English Language sentences which may become aligned to the context of said Native memory in FIG. 1 item (8) and item (11) as defined by the user when said application is in learn mode storing actions with said memories in FIG. 1 item (8) and (11).

Said common memory in FIG. 1 item (5) enables the following functionality to occur in said application using deductive and inference based reasoning. In deductive based reasoning input English Language sentences show in FIG. 1 item (1) may include a stream of declarative sentences such as: (My car will not start. There are no headlights. What is wrong?). Where said sentence: (What is wrong?) resides in common memory and causes deductive based processing of said two input sentences: (My car will not start. There are no headlights.). Said common memory sentence stored in FIG. 1 item (5) uses fuzzy logic such that variation of said sentence: (What is wrong?) can include: (get a solution. What is it?) where these variations are connected to the same action causing said deductive solution to the English Language input sentences in FIG. 1 item (1): (My car will not start. There are no headlights.). Said common memory sentences (What is wrong? etc.) have stored actions attached to said sentences as shown in FIG. 1 item (5) causing the appropriate process to occur when said sentences (My car will not start. There are no headlights.) are processed in memories in FIG. 1 items (8) and (11).

Said declarative input sentences for deductive based reasoning are fired into computer memory based on matches found in Native and text memory at locations FIG. 1, items (8) and (11). Stored actions associated with each declarative input sentence define a confidence factor when all input declarative input sentences match all stored declarative sentences shown in FIG. 1 items (8) and (11). Associated stored actions found with matching input sentences and stored declarative sentences found in items (8) and (11) cause an expected result which could include sending a new English Language sentence to the input located in FIG. 1 item (13). The stored actions may contain a number of sentences the are either fed back to the input in at FIG. 1 item (13) or to external computers, humans, or appliances in FIG. 1 item (14). Where an appliance accepts an English Language sentence, reacts to that sentence, and sends an English Language sentence back to the sending device as in FIG. 1 item (1) or other devices in a network. All generated English Language sentences resulting from memory transactions whether generated from a stored action or composed using internal parsing technology in FIG. 1 item (2) interact with the memory of said computer application or the memories of other devices creating a dialog using English Language sentences between devices. Any decoded English Language sentence results in the activation of a stored action. A simple device may decode specific English Language sentences (decoded to ASCII text for processing) sent from said application resulting in said device sending back an English Language sentence in response to said application or other said applications or other devices or humans either as text, voice or other electrical signals represented by said English Language sentence(s). Said stored actions result in new sentences or memory switching as shown in FIG. 1 items (4), (6), (7), (9), and (10) from said application or canned sentences from appliances causing said work to be done for user.

When said application is not in the learn mode, English Language declarative input sentences shown in FIG. 1 item (1) find stored declarative sentences in FIG. 1 item (8) and item (11). When found, those declarative sentences are connected to stored actions which define the solution for deductive based reasoning. Associated solutions include English Language sentences that may be fed back to the input FIG. 1 item (13) or go outside of the said computer application shown at FIG. 1 item (14) to other devices. Those devices can be said computer application running on other computers or appliances. In all cases, outside sources, either human or machine, communicate to each other in English Language sentences.

Said computer application can integrate deductive based reasoning with inference based reasoning. Deductive based reasoning is the storage of English Language sentences connected together within and across object memories. Connecting sentences and object memory together occurs in the learn mode as user defines connecting relationships between sentences. User typically enters declarative sentences in FIG. 1 items (1) and (13) which map into learned stored connected sentences in object memory in FIG. 1 items (5), (8), and (11). A typically example session could include the following input sentences: (go to vehicle memory. My car will not start. There is no dome light. What is wrong?). When said computer application receives first said sentence: (go to vehicle memory.) said application switches to vehicle object memory in FIG. 1 items (8) and (11). Once switched, said second sentence: (My car will not start.) finds a sentence match in current open object vehicle memory. Matched said sentence (My car will not start.) has an attached sentence: (go to start problem memory.) Said computer application builds new remaining sentences: (go to start problem memory. There is no dome light. What is wrong?) and said computer application switches to: (go to start problem memory) in FIG. 1 item (13) causing new object memory to open in FIG. 1 items (8) and (11). Next input sentence of remaining sentences: (There is no dome light. What is wrong?) finds matching sentence in current open object memory (go to start problem memory.) in FIG. 1 items (8) and (11). As said matching sentences are found throughout object memories, said attached actions to each matching sentence is stored in said computer application RAM area noting the number of matched sentences compared to the number of matched sentence with a group as defined by the user in said application learn mode. Said last sentence: (What is wrong?) causes said application to find said sentence in object common memory in FIG. 1 item (5). Said sentence: (What is wrong?) has attached actions that causes said application to process data stored in said computer application RAM resulting form said sentence matches found in said object memory in FIG. 1 items (8) and (11). Resulting said solution: (The car battery may be dead or disconnected. Confidence factor 100 percent). Said data in Ram may also include sentences: (go to battery memory. battery provides power.) such that when user inputs: (What should I do?—asking said application to make an inference or alternative to using a battery, and where said sentence: (What should I do?) exists in said common object memory in FIG. 1 item (5)) said application transfers said sentences: (go to battery memory. Battery provides power.) to FIG. 1 item (13). Said inference sentences: (go to battery memory. Battery provides power.) switch to battery memory as directed by input sentence: (go to battery memory.) in FIG. 1 items (8) and (11). Next said input sentence: (Battery provides power.) finds said sentence in battery object memory in FIG. 1 items (8) and (11). Said sentence: (Battery provides power.) has attached sentence: (go to electrical power memory.) causing said application to switch object memory in FIG. 1 items (8) and (11). Said application isolates verb (provides) and searches through object memory: (go to electrical power memory.) for said verb (provides) at same said hierarchical level of 2 as defined by said previous sentence: (Battery provides power.). Said computer application finds sentence in said open object memory (go to electrical power memory.) in FIG. 1 items (8) and (11) finds sentence: (Devices provide electrical power.). Said found sentence: (Devices provide electrical power.) at hierarchical level 2 has attached user comment: (Replace or recharge battery.).

Said application uses multi sentence technology to: 1) open new object memory; 2) find matches in object memory in FIG. 1 items (5), (8), and (11) as defined by input from FIG. 1 items (1) and (13); 3) cause said found sentence to execute any action as defined by said attached computer programs; 4) send attached sentences found in memory at FIG. 1 items (5), (8), and (11) to output in FIG. 1 items (14) to said other computers using said application or devices responding to said English Language sentences or their said symbolic derivatives; 5) enable parallel computing where said computer or human dialog in English Language is sustained using said application within or across computer platforms is complete and dialog stops such that all sentences have competed resulting in work being done by said application. Said found sentences in FIG. 1 items (5), (8), and (11) apply new sentences to input at FIG. 1 item (13). Input sentences at FIG. 1 item (1) or item (13) can be from 1 to N sentences where sentences from FIG. 1 item (13) can be attached to stored sentences in FIG. 1 items (5), (8), and (11). Input sentences in FIG. 1 item (1) can be composed by human or machine in any number from 1 to N.

Said application logically processes input sentences such that the following example input sentences coming from FIG. 1 item (1) or (13) from deposited sentences in FIG. 1 items (5), (8), and (11) are: (please play cards. If you played cards then show card instructions. Otherwise, play a game of chess.) Where said application finds match in said object memory in FIG. 1 items (5), (8) and (11) for said sentence: (please play cards.) noting that if said match did not occur from input in FIG. 1 items (1) or (13) and said open object memory in FIG. 1 items (5), (8), and (11) that said application generates internal message: (my memory is blank.). When said message is generated (my memory is blank.) because said application could not find match to said input sentence: (please play cards.) to said memory, said next input sentence: (If you played cards then show card instructions.) is disregarded such that the sentence: (Otherwise, play a game of chess.) is processed through said application memory in FIG. 1 items (5), (8) and (11) resulting said application playing the computer game of chess. Said application with said stored English Language sentences stored in said object memories in FIG. 1 items (5), (8), (11) have attached sentences that can be sent to said application output in FIG. 1 item (14) or display on said application user screen or put into ASCII text to voice transducer such that when said input sentences matches said memory sentences with said attached action which could be a said English Language sentences, that said sentence could be announced to a local or remote speaker.

Said application can be programmed in ordinary English Language sentences by storing said sentences in said object memories in FIG. 1 items (5), (8), and (11). Format of said stored English Language sentences can be generated by computer program and auto loaded into said application object memory. Said application can request auto load of new said application object memories to adapt to new requirements as defined by an English Language sentence form human or machine.

Said application uses two methods to sort through user object memory in FIG. 1 items (5), (8), and (11). Method 1 indexes said object memory in FIG. 1 item (8) to open object memories in FIG. 1 item (11) with single sentence input or multi sentence input. Method 2 builds internal sentences to reapply those sentences in FIG. 1 item (13) in order to sort through object memory in FIG. 1 items (5), (8), and (11). In Method 1, human or machine enters sentence(s) in FIG. 1 item (1) or said application enters sentence(s) in FIG. 1 item (13). Said object memory switches object memory based on attached sentence associated with matched sentence in FIG. 1 items (5), (8), and (11). For example, the input sentence(s): (Go to New York memory. Who is John Smith?) causes said index sentence: (Go to New York memory.) to switch to New York object memory when said application is told with an English Language sentence to: (please go into search mode.). (Go to New York memory.) is in an index of all object memories located in FIG. 1 item (8). Attached action of said found sentence (Go to New York memory.) switches object memory to New York memory in FIG. 1 items (8) or item (11). Said next sentence locates said sentence (Who is John Smith?) through existing index or in memories in FIG. 1 items (11) or items (5). Said open object memory is open containing 1 of N sentences of which one is fuzzy similar to (Who is John Smith?). Said next sentence: (Who is John Smith?) searches for a match in said open object memory in FIG. 1 items (8), and (11) and displays answer to (Who is John Smith?) as defined in said computer application learn mode. In said learn mode, user would have previously stored and defined a sentence like: (“John Smith New York friend” is “John Smith is a friend from New York.”) whereby the input sentence: (Who is John Smith?) in FIG. 1 items (1) or (13) would look for a match in FIG. 1 items (5), (8), and (11) such that the input sentence is parsed (broken apart according to the rules: sentence=noun phrase+verb phrase) in FIG. 1 item (2) or their derivatives and applied against the stored sentence: (Who is John Smith?) found in FIG. 1 items (5), (8), and (11). Found said sentence: (Who is John Smith?) may have 1 of N stored actions. Said stored actions can include any combination of English Language sentences and other data types depending on user configuration of stored sentence in FIG. 1 items (5), (8), and (11). Said stored actions are attached to said stored sentence in said computer application using said computer application learn mode. Said stored sentences and said stored actions are stored in Native, text or SQL data types as shown in FIG. 1 items (5), (8), and (11).

1. Said application can carry out spontaneous (positive value work occurs) English Language conversations with other said application(s) running on various computers and devices.

2. Computer memory for said application is English Language sentences that may be constructed by people or machine using the English Language.

3. Said application can dynamically change the way it processes an English Language sentence using said previous English Language sentences which reconfigures said application.

4. Said application can dynamically switch memories (defined as a group of English Language sentences) based on an English Language sentence input from another device, human, or said application sending a new English Language sentence fed back into the input. in FIG. 1 item (13) from said application's memories in FIG. 1 items (5), (8), (11). This occurs because sentences stored in memory can have any number of attached sentences that can be sent back into the said applications input or to other devices in FIG. 1 item (14). Said other devices can send English Language sentences back to first said application in response to said applications sentences over a network.

5. Said application can be programmed by storing ordinary English Language sentences.

6. Said application can read English Language sentences stored in text files in order to teach itself (said application) with English Language sentences so that after said application has trained itself, a said last sentence in the text file that has trained said application can be used to cause said application to respond correctly to what said application has learned.

7. Said application can take an input English Language sentence, find a fuzzy match in 1 of N English Language memories (made up of English Language sentences) and having attached English Language sentences that are fed back to the input of said application in FIG. 1 item (13) such that said application utilizes several memories in FIG. 1 items (5), (8), and (11) so that said application carries out a number of coordinated actives to complete a total task made by calling one or more English Language sentences connected to 1 of N English Language sentences in FIG. 1 items (5) (8), and (11).

8. Said application with machine or human English Language input can find an existing English Language sentence using fuzzy logic with N number of actions or attached English Language sentences that can be fed back into the input at FIG. 1 item (13) or go to the output in FIG. 1 item (14) such that an English Language sentence is sent to another said application operating on other computers or devices such that said device replies in response with said English Language sentence originating from said first application. Said original application would complete English Language conversation.

9. Said application can change entire memory systems based on an English Language sentence.

10. Said application is context sensitive dynamically switching memories (made up of English Language sentences) based on input sentences.

11. Said application can process multiple English Language sentences sent to the said application as a text file, a tape recording, human, English Language sentences synthesized by a computer or any said device capable of transmitting English Language sentences.

12. Said application can logically process multiple input English Language sentences as in: please play a card game. If you can play cards then show the card game instructions. If you can not play cards, play chess.

13. Said application can take two identical sentences and return a difference answer by telling said application to switch memories (context).

14. Said application dynamically takes a single sentence and builds several sentences to search text or other file types. In this example, the following input sentence: “Who is the mayor of Chicago?” causes the said application to build two sentences: “Who is the mayor?” and “Who is the mayor of Chicago?” The first sentence: “Who is the mayor?” causes the said application to switch to mayor memory. Mayor memory then opens the appropriate text memory that when the said application receives the second sentence: “Who is the mayor of Chicago?” said application displays the appropriate answer.

15. Any device that can process English Language like constructs, parsing components into actions (verbs), prepositional phrases, noun phrases, verb phrases, adverbs, and other components such that said parsing can communicate with said mechanisms of said patent application.

16. Tagging any electronic transaction with multiple sentences such that the transaction becomes data and the tagged multiple sentences attached to the transaction(s) are English Language instructions telling said receiver or other devices of information what should be done.

17. Using English Language tags in the form of English Language sentences or English Language words to be used to define the likeness of data so that said data can be integrated in order to build new data with added value.

18. Defining any suitable standard or non standard database system holding English Language sentences such that said English Language sentences can be used to re-program said computer application.

19. Using said computer program to translate English Language sentences made from said imaging device so that said application can respond to English Language sentences made by vision devices. Said devices can be any device capable of translating observation of images, voice, and other transducers into English Language sentences and components.

20. An English Language declarative sentence (noun phrase plus a verb phrase) is reformatted such that its verb phrase (made up of a verb plus a noun phrase) where the verb phrases noun phrase may be substituted with multiple sentences such as: computer play cards is “go to game memory. please play a game of cards.” Where: is “go to game memory. please play a game of cards.” is the verb phrase and its noun phrase is “go to game memory. please play a game of cards.”

21. Claim 21 is related to claim 20 in that the back part of any sentence can call the front part of any other sentence stored in the same memory or in other memories. The same is true for native databases, text databases, SQL databases, and any other databases that store human language in any medium.

22. The computer program uses sentence logic as in: “run a computer card game if: switch to your science memory. Why is the sky blue? Otherwise call your doctor.

23. If the computer program can not answer the question: Why is the sky blue? it will be forced to learn the answer to this question by storing the appropriate English Language sentence in one of its English Language memories.

24. The computer program may learn by sending one or more English Language sentences to the input FIG. 1 item 1 or from English Language sentences read from memory at FIG. 1 item 13 coming from FIG. 1 item 12.

25. An English Language sentence my be sent to the input FIG. 1 items 1 instructing said computer application to read English Language sentences from any media such that when computer applications reads English Language sentences (FIG. 3) it has learned something by storing a sequence of English Language sentences in said computer application memory at FIG. 1 items 5, 8, 11.

26. Said computer application may learn by an inference method described in U.S. patent (U.S. Pat. No. 6,101,490) such that inference causes new English Language sentence to be stored in said computer application such that when computer is told: “My car will not start. What should I do?” said computer makes an inference from “cars transport people” to “taxi transport people” and stores said sentence in memory at FIG. 1 items 5, 8, or 11 and answers said question “What should I do? by telling said user to “take a taxi.” Said inference “taxi transport people” is stored in the appropriate computer memory at FIG. 1, items 5, 8, or 11.

27. Said computer memories may be any media that can be accessed via computers in a networked or non networked environment.

28. Said computer application may gain new knowledge by storing English Language sentences that may be converted from or to other computer data formats.

29. Said computer application my be told in English Language sentences to add new memory by a copy and past method where by new sections of memory are added to computers said memory system.

30. Said computer application uses said sentence logic as in: “run the computer game of solitaire if: locate the solitaire card game. Otherwise learn to run the game of solitaire.” Said computer application uses said logic to modify said computer memory. Said sentences (defined in this claim) may come form FIG. 1 items 1, 13.

31. Said computer application may generate goals in the form of English Language sentences such that said computer program may evolve said English Language memories at FIG. 1 items 5, 8, and 11 where items 5, 8, and 11 could be remote memory via a computer network or some other method to connect to memory that said computer application would evolve its memory by a trial and error method to eventually solve said English Language goal.
